(19) United States
(12) Patent Application Publication
(10) Pub. No.: US 2025/0131383 A1
(43) Pub. Date: Apr. 24, 2025

(54) SYSTEM AND METHOD FOR MATCHING JOB APPLICANTS TO JOB OPENINGS

(71) Applicant: Interview Magic, LLC, Tulsa, OK (US)

(72) Inventors: Rocky Wilkerson, Tulsa, OK (US); Matthew Maennche, Tulsa, OK (US)

(21) Appl. No.: 18/922,240

(22) Filed: Oct. 21, 2024

Related U.S. Application Data
(60) Provisional application No. 63/591,889, filed on Oct. 20, 2023.

(51) Int. Cl. G06Q 10/1053

(52) U.S. Cl. CPC G06Q 10/1053

(57) ABSTRACT

Disclosed herein are embodiments of a system, method, and non-transitory computer-readable storage media for matching job applicants to job openings. One or more embodiments allow for surveying applicants based on position information and criteria associated with successively smaller groups of open positions, based on survey questions derived from the most common position information at the current survey question and open position iteration, for one company or multiple companies based on applicant responses.

### CROSS-REFERENCE TO RELATED APPLICATIONS

This application claims benefit of priority under 35 U.S.C. § 119 (e) to U.S. Provisional Application No. 63/591,889, filed on Oct. 20, 2023, the entire contents and disclosures of which are incorporated herein by reference.

### TECHNICAL FIELD

The present subject matter relates to a system and method of matching job applicants to job openings.

### BACKGROUND

Finding the right job applicant for a job opening can take extensive time and resources for a company having the job opening, especially when the number of applicants is large and/or the number of job openings is large. Moreover, matching qualifications of a job applicant to a suitable job opening may be similarly difficult. There is a need to simplify these job matching processes so as to make the process quicker and take less resources.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 shows a schematic drawing of portions of a system according to the present disclosure;

FIG. 2 shows a flow diagram of a method for matching job applicants to job openings, according to some embodiments of the present disclosure;

FIG. 3 is a component block diagram showing a high-level logical arrangement of certain components for an exemplary computer system which may be employed to practice one or more embodiments set forth herein, or portions thereof; and

FIG. 4 is an illustration of a scenario featuring an example non-transitory machine-readable medium in accordance with one or more embodiments set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

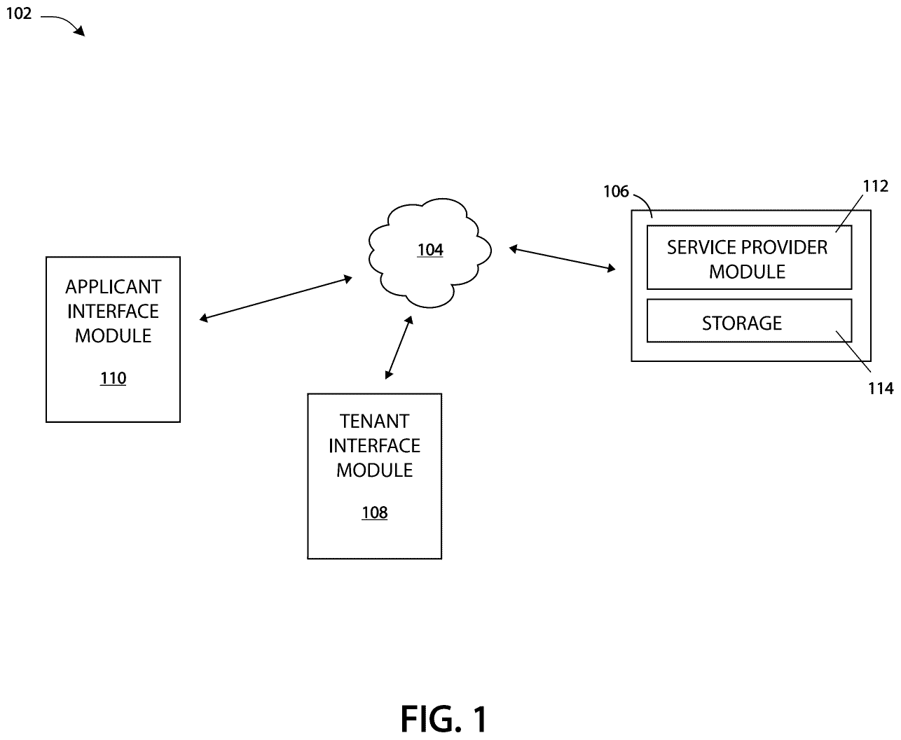

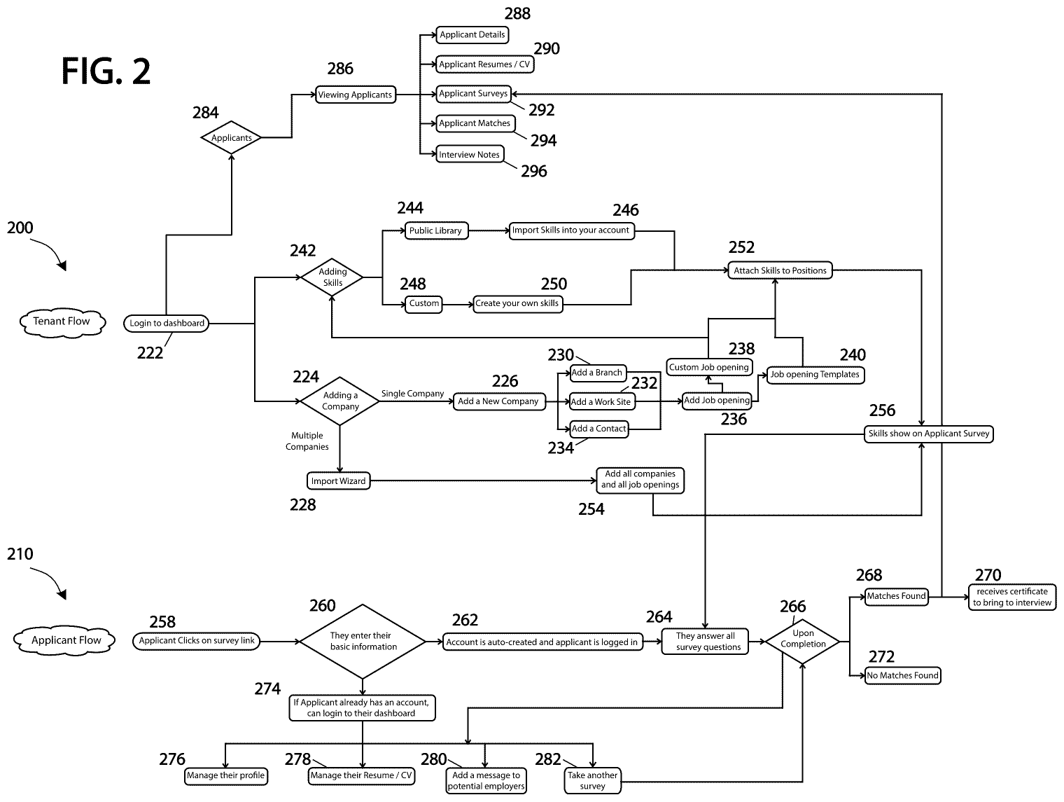

One or more novel embodiments of systems and methods for matching job applicants to job openings are illustrated by example flows 200, 210 of FIG. 2, and further described in conjunction with system 102 shown in FIG. 1, which may implement flows 200, 210. The system may be a computer system (e.g., system 102) and the method may be a computer implemented method (e.g., flows 200, 210). The method may be implemented by the computer system 102 over a communication network 104, which allows communication between a server 106, a tenant module 108, and an applicant module 110. The system and method may involve the use of one or more computer program(s) or application(s) executed on one or more of the server 106, the tenant module 108, and/or the applicant module 110. The method may be implemented online. The system 102 may operate to sift through a pool of applicants and provides a list to the tenant showing the most-qualified applicants from that pool for a particular job.

The computer system 102 includes the communication network 104, the server 106, the tenant module 108, and the applicant module 110. The server 106 may be operated by a service provider.

The server 106 includes a service provider module 112 and a storage unit 114 that is accessible by the service provider. The server 106 provides online services to the tenant through the tenant module 108 and/or to the applicant through the applicant module 110. The online services include a function of sifting through a pool of applicants and providing a list to the tenant of the most-qualified applicants from that pool for a particular job. The online services may include a service website, software as a service (Saas), a downloadable application for a mobile or stationary computing device, or other services provided through the communication network 104.

The service provider module 112 and storage unit 114 are coupled with each other for providing the online services. In the present example, the service provider module 112 may be any functional module implemented as hardware, software, or combination thereof. The service provider module 112 utilizes information relating to tenants (tenant accounts), job openings, and applicants (applicant account), which information is stored in the storage unit 114 and is used for providing the online services.

The service provider module 112 accepts a login request of a tenant account made from the tenant interface module 108, which may include a computing device with a communication module for sending the login request to the service provider module 112 via the communication network 104. In response to the login request, the service provider module 112 establishes a first communication connection with tenant interface module 108 for the transfer of information between them. The service provider module 112 also accepts a login request of an applicant account made from the applicant interface module 110, which may include a computing device with a communication module for sending the login request to the service provider module 112 via the communication network 104. In response to the login request, the service provider module 112 establishes a second communication connection with applicant interface module 110 for the transfer of information between them.

According to the respective login requests, the service provider module 112 provides a first online service corresponding to the tenant interface module 108 over the first communication connection, and a second online service corresponding to the applicant interface module 110 over the second communication connection.

With reference to FIG. 2, a computer implemented method includes the first online service including a tenant flow, generally indicated at 200, and the second online service including an applicant flow, generally indicated at 210.

### Tenant Flow—Job Opening Management

As part of the first online service, the tenant flow 200 includes at 222 a tenant logging into a tenant account via the tenant interface module 108. The tenant may be an employer, a search firm representing one or more employers, government agencies, or others having job openings that need to be filled. The tenant may login by initially creating the tenant account, which may include adding relevant information about the tenant, which information is stored in the storage unit 114 of the server 106. The tenant may also subsequently login to the tenant account by adding information, such as a password previously created by the tenant and associated with the tenant account. Once logged in, the service provider module 112, as part of the first online service provided to the tenant, allows for the following transfer of information between the tenant interface module 108 and the service provider module 112 to occur.

The tenant may choose to add at 224 information about a new company that has one or more job openings, which information is to be stored in the storage unit 114. As used herein, “add” and cognate terms means to input information into, or import information through, one of the tenant interface module 108 or the applicant interface module 110, which information is stored in the storage unit 114 for use by the service provider module 112. The new company may be the tenant itself or may be an individual, company or organization that is using the tenant to find an applicant for a job opening(s). The tenant may choose to add a single new company at 226 or may choose to add multiple new companies at 228. If a single new company is added, the tenant may add at 230 information about a branch of the new company where the job opening is located, add at 232 information about a work site of the new company where the job opening is located, or add at 234 contact information for the new company. Thereafter, the tenant can add at 236 a job opening (also referred to herein as “position”) that are available at the new company by adding a custom position at 238 or by using a position template at 240.

After the new position(s) is/are added, the tenant can add at 242 the desired skills/qualifications/criteria for the position(s). The skills may each be in the form of a question for the applicant to answer during an applicant survey 256, which survey is discussed in more detail herein. The skills can be added into the tenant account by selecting at 244 skills/questions from a public library of skills/questions and by importing at 246 the selected skills/questions, or by adding at 246 custom skills/questions by creating at 250 the custom skills/questions. The imported or created skills/questions can then be associated to the relevant position(s) at 252, which association is saved in storage unit 114 for use by the service provider module 112.

Each skill or other characteristic of the job applicant can be classified by the tenant as “required”, “acceptable”, “bonus”, “disqualified”, or “explain”. “Required” means that the applicant must affirm they have the skill or other characteristic in order to qualify for that particular job opening. “Acceptable” means that the applicant's skill level or other characteristic is within an acceptable range to meet the requirements of the job opening. “Bonus” means the applicant's skill or other characteristic would qualify him for a bonus in pay if he were hired for the job opening. “Disqualified” means the applicant's skill level or other characteristic is outside an acceptable range to meet the requirements of the job opening. “Explain” means the applicant's skill level or other characteristic does not necessarily disqualify him from the job opening, but that the applicant must provide a further explanation about the skill level or other characteristic.

The tenant may add multiple new companies by accessing at 228 an import wizard via the tenant interface module 108 as part of the online services. The import wizard 228 allows the tenant to upload and add at 254 information to the server 106 relating to the multiple new companies and all job openings associated with the multiple new companies. This information may be available from the tenant (e.g. previously created) and uploaded via the tenant interface module 108, and then added to the storage unit 114 in a standardized format via the import wizard. The information added by the tenant and saved in the storage unit 114 may be presented to a job applicant in an applicant survey 256, discussed in more detail herein.

### Applicant Flow

To match the skills of a job applicant to a particular job opening, questions relevant to the skills/qualifications needed for that particular job opening may be presented to the job applicant as part of an applicant survey 256 in the form of question(s) to answer.

As part of the second online service and when a job applicant wants to apply for a job opening, the applicant flow 221 may include an access link being sent via the server 106 and over the communication network 104, such as through an email or text message, to the job applicant via the applicant interface module 110. The sending of the access link to the job applicant may be initiated by the tenant or by an individual, company or organization that is utilizing the tenant to find a job applicant for a job opening. The access link may be sent to the job applicant in response to instructions input into the tenant interface module 108 by the tenant. The job link may also be sent automatically by the server 106 in response to the job applicant entering input into the applicant interface module 110, such as the job applicant using the applicant interface module 110 to scan a QR code associated with the job opening, thus causing the applicant interface module 110 to send a request to the server 106 to send the access link.

The job applicant may access the second online service by activating at 258 the access link, such as by clicking on a virtual icon on the applicant interface module 110. This access may include the job applicant downloading a mobile application that is executed on the applicant interface module 110 as part of the second online service. After accessing the second online service, the service provider module 112, as part of the second online service, allows for the following transfer of information between the applicant interface module 110 and the service provider module 112 to occur.

The job applicant may choose to add at 260 basic information relating to the job applicant so as to create, or login to, an applicant account that is saved on the storage device 114. The job applicant may be prompted on what basic information to add, and this may include one or more of a name, username, password, date of birth, address, phone number, or other information, etc. associated with the job applicant. This adding of basic information relating to the job applicant may allow the job applicant to create the applicant account if one has not already been previously created by the job applicant, or may allow the job applicant to access the applicant account if it has already been created and saved in the storage unit 114. To login to an already existing applicant account that is saved in the storage unit 114, the job applicant may be required to subsequently login to the applicant account by entering information into the applicant interface module 110, such as a password previously created by the job applicant and associated with the applicant account.

Adding the basic information relating to the job applicant may result in the creation at 262 of a new applicant account associated with the job applicant and saved in the storage unit 114, after which the job applicant may participate in at 264 the applicant survey 256 (discussed in more detail herein). The applicant survey 256 taken by the job applicant may be associated to the access link sent to the job applicant, and the survey 256 may be associated with a particular job opening(s) and/or with a particular employer/tenant having the job opening(s) that needs to be filled.

Adding the basic information relating to the job applicant may allow the job applicant to login at 274 to an already existing applicant account associated with the job applicant and saved in the storage unit 114. When logged in at 274 or after completing at 266 an applicant survey, the job applicant may manage at 276 an applicant profile associated with the applicant account, manage at 278 an applicant resume associated with the applicant account; add at 280 a message to a potential employer; or participate in at 282 another applicant survey.

The second online service provides an option for the job applicant to add at 278 a resume, which may be digitized by the server 106 such that different portion of the resume (e.g. education, work experience, etc.) can be parsed out and put into a standardized digital template for the tenant to see on the tenant interface module 108.

### Applicant Survey

The applicant survey 256 may include presenting a series of questions to the job applicant through the applicant interface module 210. The series of questions are associated to the job openings of a particular tenant and relate to the skills or other characteristic desired for the job application by the particular tenant for its job openings. The job applicant will answer the series of questions by adding their answers to the questions through the applicant interface module 110.

Each question in the applicant survey is presented based upon it being the most common question associated with all the job openings for which the job applicant is qualified. The answer to each question may disqualify the job applicant from some of the job openings, thus leaving only a remainder of the job openings. Any subsequent question presented to the job applicant will be the most common question associated with all the remainder of the job openings. This process of 1) presenting a question to the job applicant, 2) the job applicant adding and answer, and 3) presenting a subsequent question to the job applicant, may be repeated until there are no questions left to present to the job applicant, either because there are no question left that are associated to the job openings of the particular tenant or because the job applicant has been disqualified from all the job openings of the particular tenant, at which point the applicant survey is completed.

### Matching Process

Once the applicant survey 256 is completed at 266 by the job applicant, the server 106 processes the information added during the applicant survey 256 and compares this information with the skills or other characteristic required for the job openings, and either determines a match at 268 between the job applicant's skills or other characteristic and the requirements for the job opening(s), or determines no match at 272 between the job applicant's skills or other characteristic and the requirements for the job opening(s).

The first online service may present at 292 the tenant with a list of job applicant(s) matched to the job opening(s). If there are multiple job applicants that take the applicant survey 256, then the server 106 may select only the qualified applicants and send their information to the tenant (rather than the tenant having to review applications/resumes for every single applicant to find one that is qualified for the job openings). As used herein, “qualified” and cognate terms means the job applicant's skills or other characteristic, as determined by the job applicant's answers to the applicant survey 256, are within an acceptable range to meet the requirements of the job opening.

If there are multiple qualified applicants, then the server 106 may select only the most-qualified applicants (those with the highest skills) and send their information to the tenant, in the form of a ranked list of most-qualified to least-qualified. The list may be presented to the tenant via the tenant interface module 108. If there are no matches between the job applicant's skills or other characteristic and the requirements for a job opening(s), the first online service may present at 292 such an indication to the tenant via the tenant interface module 108, and the server 106 may send information to the tenant on the applicants that are closest to being qualified for the job opening(s).

The second online service may present at 268 the job applicant with a list of job opening(s) matched to the job applicant's skills if any, and also may send an indication at 292 to the tenant via the tenant interface module 108 that this particular job applicant qualifies/does not qualify for the job opening(s). This list of job opening(s) matched to the job applicant's skills may be presented to the job applicant via the applicant interface module 110, and the job applicant may be presented at 270 with a certificate (e.g. a digital certificate) indicating the match(es) with the job opening(s), which certificate can be presented to an employer around the time of an employment interview between the employer and the job applicant. If there is no match between the job applicant's skills and those required for a job opening(s), the second online service may present at 272 an indication to the job applicant that there are no matches. This indication presented to the job applicant via the applicant interface module 110 may be an indication as to what type of jobs the job applicant qualifies for, rather than an indication of a particular job(s) the applicant qualifies for. This indication may also show a different job than the one for which the job applicant applied.

### Tenant Flow—Job Applicant Management

After one or more job applicants have taken an applicant survey 256 associated with the tenant, the tenant may manage at 284 job applicants by viewing at 286 one or more applicants that took the applicant survey 256. This may include viewing at 288 information relating to the job applicant(s) that took the particular applicant survey 256, which may include information associated with the applicant account such as personal information of the job applicant; viewing at 290 a resume of the job applicant; viewing at 292 the completed applicant survey taken by the job applicant; viewing at 294 a list of the most-qualified applicants for the job opening; or viewing at 296 notes taken during an interview of the job applicant.

### Example

The following example is presented for illustration, and does not limit the scope of the present subject matter.

During the applicant survey 256, the job applicant is presented with a series of questions. The first question is the most common question to all the job openings available with the tenant. Applicant's answer to the first question may disqualify the job applicant from some of the job openings. For instance, the most common question for all the job openings of a tenant might be, “where do you live?”. If the job applicant answers “Ohio”, then the applicant may be excluded from some jobs that are based outside of Ohio. Some jobs might be remote, and thus do not have such a question associated with them. Therefore, the applicant may not be disqualified from a remote job no matter the answer that is given to this question and thus remote jobs remains a job for which the job applicant is qualified.

Based on job applicant's answer of living in Ohio, the next question presented to the job applicant as part of the applicant survey 256 is the question that is most common for all the remaining, non-excluded, job openings in the system, e.g. all the jobs in Ohio and all remote jobs. Thus, the second question is selected based on the applicant's answer to the first question. That is, all the remaining jobs, i.e. those in Ohio and remote jobs, are analyzed by the server 106 and the question that is most common for all of these remaining jobs is presented as the second question. Based on the applicant's answer to the second question, the applicant may be excluded from applying to still more jobs of the tenant. For example, the second question might be “what are your salary requirements?”. If the applicant answers “over $100,000”, then the applicant may be excluded from jobs that pay less than $100,000 even if they are in Ohio or are remote.

The server 106 runs this iteration of presenting questions to the job applicant until there are no questions left to present to the job applicant, either because there are no questions left for job openings of the tenant that the job applicant qualifies for, or because the job applicant has been excluded from all the available jobs of the tenant. At this point, the applicant may be qualified for zero, one, or more job openings of the tenant.

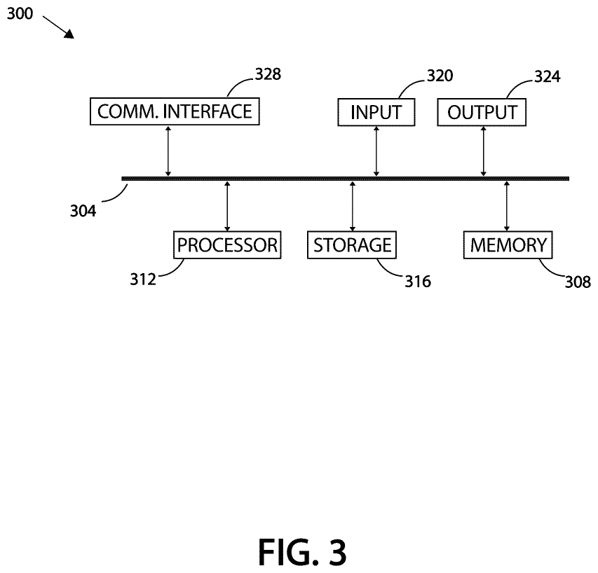

The systems and methods for matching job applicants to job openings may be performed on or by one or more computer systems (one or more computing devices, alone or in combination with one or more other computing devices and/or systems), accordingly to the embodiments described herein. Generally, computer systems (such as, e.g., computing devices described in relation to system 102) may comprise any suitable machines sufficient to run one or more aspects of the systems described herein and provide the functionality described herein. For example, components of exemplary computer system 300 shown in FIG. 3 may be used to implement server 106, storage 114, and/or service provider 112. In some embodiments, portions of the applications, components, modules, routines, operations, etc. described herein may be implemented on computer system 300.

FIG. 3 is a block diagram showing a high-level logical arrangement of certain components for an exemplary computer system 300 which may be employed to practice embodiments or portions of embodiments of the present disclosure. Bus 304 ties system components including memory 308 (e.g., ROM and/or RAM) to processor 312. Bus 304 may generally be any suitable type of bus structure using any suitable bus architecture, such as for example, a memory bus or controller, system bus, peripheral bus, or a local bus, etc. In some embodiments, bus 304 may include specialized architectures such as shared memory for integrated GPU(s) or on-chip interconnects. Information transfer to/from the bus (and components) may be accomplished by any suitable means, such as for example a BIOS stored in ROM 308 or the like. Memory 308 may also include specialized memories such as local caches and registers. Device 300 may have more than one processor 312 or may comprise a group or cluster of computing devices 300 networked together to provide greater processing capacity. Processor 312 may include any general-purpose processor(s), such as a CPU, as well as any special-purpose processor(s), such as a vision processing unit(s) (VPU). Device 300 may include storage 316 (e.g., flash memory, hard disk drive, magnetic or optical disk drive, or the like). Storage 316 may include software, data and/or instructions for performing functions such as controlling processor 312. In general, the non-transitory computer readable storage media (memory and/or storage) provide nonvolatile storage of computer readable instructions, data structures, program modules and data for processing device 300. A person of ordinary skill in the art would know how to make variations to the basic components described to suit a particular function or need. Non-transitory computer-readable storage media expressly exclude media such as energy, carrier signals, electromagnetic waves, and signals per se.

With continuing reference to FIG. 3, computing device 300 may comprise input devices 320 and output devices 324. In general, input devices 320 may be any number of input means, such as a digital camera or camera sub-system (e.g., e.g., CCD or CMOS-based camera sub-system), microphone for speech, a touch-sensitive screen for gesture or graphical input, a keyboard, mouse, and the like. Also in general, output devices 324 may include any number of output means, such as for example a visual monitor (touchscreen, LCD, CRT, etc.), a printer, and the like.

Communications interface(s) 328 generally governs and manages the user or system input and system output. A person of ordinary skill in the art would know how to make variations to the basic components described to suit a particular function or need, and that the basic features described here may be substituted with improved software, hardware or firmware arrangements as they are developed. Additionally and/or alternatively, communications interface 328 may generally comprise any network interface sufficient to provide the functionality described herein. For example, interface 328 may enable computing system 300 to communicate data and messages to one or more external devices in a networked environment, using generally any suitable communication protocol.

The exemplary computing system of FIG. 3 is illustrated as including individual functional blocks. In general, the functions represented by these blocks may be provided through the use of either shared or dedicated hardware, including but not limited to, hardware capable of executing software and hardware that is purpose-built to operate as an equivalent to software executing on a general-purpose processor. Some embodiments may include CPU, GPU, VPU, microprocessor and/or digital signal processor (DSP) hardware, read-only memory (ROM) for storing software performing the operations described herein, and random access memory (RAM) for storing results. Logical operations of various embodiments described herein may be implemented as, for example, a sequence of computer implemented steps, operations, or procedures running on a processor or processing resource within one or more general or specific-use computers. Device 300 may practice all or part of the recited methods, may be a part of the recited systems, and/or may operate according to instructions in the recited non-transitory computer-readable storage media. Such logical operations may be implemented as modules or components configured to control processor 312 to perform particular functions according to the programming of the module/component.

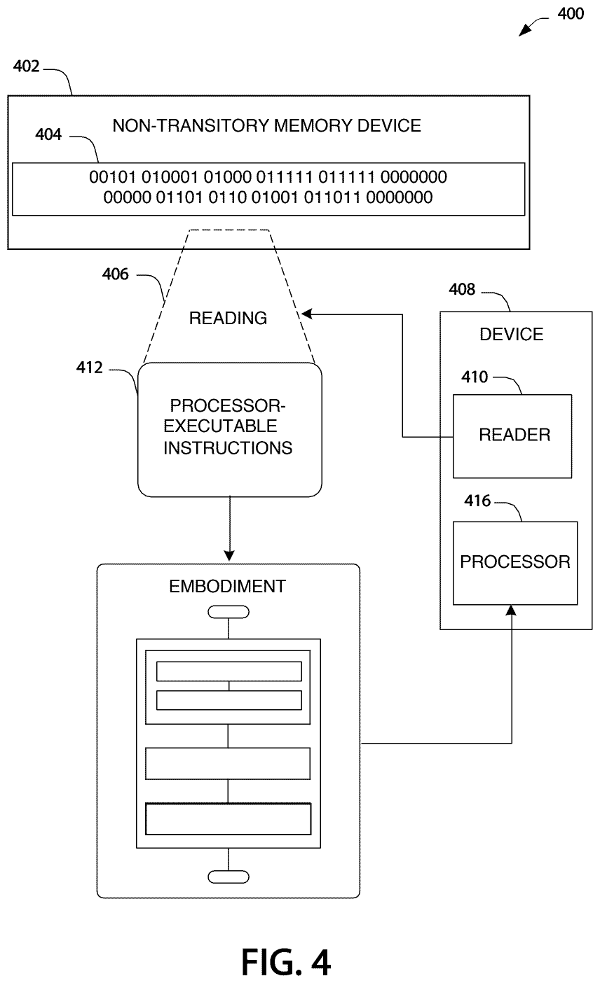

FIG. 4 is an illustration of a scenario 400 involving an example non-transitory machine readable medium 402. The non-transitory machine readable medium 402 may comprise processor-executable instructions 412 that when executed by a processor 416 cause performance (e.g., by the processor 416) of at least some of the provisions herein. The non-transitory machine readable medium 402 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 402 stores computer-readable data 404 that, when subjected to reading 406 by a reader 410 of a device 408 (e.g., a read head of a hard disk drive, or a read operation invoked on a solid-state storage device), express the processor-executable instructions 412. In some embodiments, the processor-executable instructions 412, when executed cause performance of operations, such as at least some of the example method 200,210 of FIG. 2, for example. In some embodiments, the processor-executable instructions 412 are configured to cause implementation of a system, such as at least some of the example system 102 of FIG. 1, for example.

Many other benefits will no doubt become apparent from future application and development of this technology.

It should be understood that an aspect, element, feature, structure, function or characteristic that is described in relation to an embodiment is not necessarily limited to the embodiment described, but rather may be applicable to one or more embodiments, unless expressly stated otherwise. Similarly, the phrases “in an embodiment,” “in some embodiments,” or similar phrases, appearing in the present disclosure are not necessarily all referring to the same embodiment or the same set of embodiments. Also, the description set forth herein is not to be construed as limited to the embodiments shown; rather, it is appreciated that various modifications may occur to those skilled in the art that, while not specifically set forth herein, are nevertheless within the spirit and scope of the description. When an embodiment is described as “exemplary”, “particularly,” or the like, herein, it is to be understood as one non-limiting example embodiment, and does not preclude other embodiments that may not include the limitations described in the exemplary embodiment. Further, unless expressly stated otherwise, “or” refers to an inclusive or and not to an exclusive or. Any implementation described herein as exemplary is not necessarily to be construed as preferred or advantageous over other implementations. There is no intention to be bound by any expressed or implied theory presented in the preceding technical field, background, or

### DETAILED DESCRIPTION

Certain terminology used in the this description is for the purpose of reference only, and thus is not intended to be limiting. For example, terms such as “upper”, “lower”, “above”, and “below” refer to directions in the drawings to which reference is made. Terms such as “front”, “back”, “rear”, “side” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms do not imply a sequence or order unless clearly indicated by the context.

Conventional techniques related to processing, data transmission, signaling, network control, and other functional aspects of the systems and/or components may not be described in detail herein for the sake of brevity. Further, connecting lines in various figures contained herein are intended to represent exemplary functional relationships and/or physical couplings between the various elements, but it should be noted that many alternative or additional functional relationships or physical connections may be present in an embodiment of the subject matter.

As may be appreciated by one of skill in the art, aspects of the embodiments described herein may be employed as a system, method or computer program product. Accordingly, aspects may take the form of a hardware embodiment, a software embodiment (including firmware, etc.) or an embodiment combining hardware and software.

Aspects of the present embodiments described herein may take the form of a computer program product embodied in one or more computer readable medium(s) having computer readable program code represented thereon. Further, the systems and methods described herein may be applied as standalone systems or methods, or as part of an integrated package, such as a farm or field management package or application.

As also may be appreciated by one of skill in the art, aspects of the embodiments described herein as functions, routines, algorithms or methods may be implemented in software, which software may comprise computer executable code/instructions stored on computer readable media. Multiple functions may be performed in one or more modules as desired, and the embodiments described are merely examples. The software may be executed on one or more DSP, CPU, GPU, ASIC, FPGA, SoC, microprocessors, or other type of processors operating on one or more computer systems or processor environments, such as a personal computer, server, PaaS, or other computing system.

When dealing with software embodiments, the embodiments are not dependent on any particular software language or type of language, unless context suggests otherwise, and in general any suitable programming language may be employed. When dealing with APIs, libraries, components, modules, or similar software concepts and constructs, code may be described abstractly using functional language or using pseudocode or other high level description. Unless context suggests otherwise, the terms “module” and “component” may be used interchangeably herein. Generally, modules and components may be considered to be portions of related code that perform one or more related routines (functions/methods) and are portions of a larger whole, and whose scope may vary. In some circumstances, they may comprise one or more class libraries of an application that provide one or many routines (functions/methods), while in others they may refer to a single application of an application suite.

The various tasks performed in connection with the process may be performed by software, hardware, firmware, or any combination thereof. For illustrative purposes, the description of the process may refer to elements mentioned above. In practice, portions of the process may be performed by different elements of the described system, e.g., component A, component B, or component C. It should be appreciated that process may include any number of additional or alternative tasks, the tasks shown need not be performed in the illustrated order, and the process may be incorporated into a more comprehensive procedure or process having additional functionality not described in detail herein. Moreover, one or more of the tasks could be omitted from an embodiment of the process as long as the intended overall functionality remains intact.

Although at least one exemplary embodiment has been presented in the foregoing detailed description, it should be appreciated that any number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

1. A computer implemented method comprising:
Adding entity information based on a first company to a job matching service using a tenant interface of the job matching service;
Adding first position information based on a first job opening of the first company to a position library of the job matching service using the tenant interface, wherein the position library comprises position information based on a plurality of job openings;
Configuring the first position information with first attribute information, wherein the first attribute information comprises parameter information sufficient to characterize an applicant response as having required, acceptable, bonus, disqualifying, and/or unexplained response information;
Adding applicant background information based on a new applicant to the job matching service using an applicant interface of the job matching service;
Determining, by the job matching service, a first group of job openings based on the applicant background information, wherein the first group of job openings comprises a first group of position information stored in the position library and that is associated with the first group of job openings;
Displaying on a screen of the applicant interface a first survey question, wherein the first survey question is based on the first group of position information;
Receiving, by the job matching service, a first applicant response to the first survey question;
Determining, by the job matching service, a second group of job openings based on the first applicant response, wherein the second group of job openings comprises a second group of position information stored in the position library and that is associated with the second group of job openings, and wherein the second group of job openings is a subset of the first group of job openings;
Displaying on the screen of the applicant interface a second survey question, wherein the second survey question is based on the second group of position information; and
Receiving, by the job matching service, a second applicant response to the second survey question.

2. The method of claim 1, wherein the first survey question is based on a subset of the first group of position information that is associated with the greatest number of job openings in the first group of job openings.

3. The method of claim 2, wherein the second survey question is based on a subset of the second group of position information that is associated with the greatest number of job openings in the second group of job openings.

4. The method of claim 2, wherein the second group of job openings is a null set and wherein the second survey question comprises a message that no further questions are forthcoming.

5. The method of claim 1, wherein the entity information comprises information about a work site of the first company where the first job opening is located.

6. The method of claim 1, wherein the position library comprises a position public library comprising position information based on a plurality of job openings of a plurality of companies.

7. The method of claim 6, wherein the first survey question is based on a subset of the first group of position information that is associated with the greatest number of job openings in the first group of job openings.

8. The method of claim 7, wherein the second survey question is based on a subset of the second group of position information that is associated with the greatest number of job openings in the second group of job openings.

9. The method of claim 7, wherein the second group of job openings is a null set and wherein the second survey question comprises a message that no further questions are forthcoming.

10. A non-transitory computer-readable medium storing instructions that when executed facilitate performance of operations comprising:
Adding entity information based on a first company to a job matching service using a tenant interface of the job matching service;
Adding first position information based on a first job opening of the first company to a position library of the job matching service using the tenant interface, wherein the position library comprises position information based on a plurality of job openings;
Configuring the first position information with first attribute information, wherein the first attribute information comprises parameter information sufficient to characterize an applicant response as having required, acceptable, bonus, disqualifying, and/or unexplained response information;
Adding applicant background information based on a new applicant to the job matching service using an applicant interface of the job matching service;
Determining, by the job matching service, a first group of job openings based on the applicant background information, wherein the first group of job openings comprises a first group of position information stored in the position library and that is associated with the first group of job openings;
Displaying on a screen of the applicant interface a first survey question, wherein the first survey question is based on the first group of position information;
Receiving, by the job matching service, a first applicant response to the first survey question;
Determining, by the job matching service, a second group of job openings based on the first applicant response, wherein the second group of job openings comprises a second group of position information stored in the position library and that is associated with the second group of job openings, and wherein the second group of job openings is a subset of the first group of job openings;
Displaying on the screen of the applicant interface a second survey question, wherein the second survey question is based on the second group of position information; and
Receiving, by the job matching service, a second applicant response to the second survey question.

11. The non-transitory computer-readable medium of claim 10, wherein the first survey question is based on a subset of the first group of position information that is associated with the greatest number of job openings in the first group of job openings.

12. The non-transitory computer-readable medium of claim 11, wherein the second survey question is based on a subset of the second group of position information that is associated with the greatest number of job openings in the second group of job openings.

13. The non-transitory computer-readable medium of claim 11, wherein the second group of job openings is a null set and wherein the second survey question comprises a message that no further questions are forthcoming.

14. The non-transitory computer-readable medium of claim 10, wherein the entity information comprises information about a work site of the first company where the first job opening is located.

15. The non-transitory computer-readable medium of claim 10, wherein the position library comprises a position public library comprising position information based on a plurality of job openings of a plurality of companies.

16. The non-transitory computer-readable medium of claim 15, wherein the first survey question is based on a subset of the first group of position information that is associated with the greatest number of job openings in the first group of job openings.

17. The non-transitory computer-readable medium of claim 16, wherein the second survey question is based on a subset of the second group of position information that is associated with the greatest number of job openings in the second group of job openings.

18. The non-transitory computer-readable medium of claim 16, wherein the second group of job openings is a null set and wherein the second survey question comprises a message that no further questions are forthcoming.
